(19) United States
(12) Patent Application Publication
(10) Pub. No.: US 2014/0108982 A1
(43) Pub. Date: Apr. 17, 2014

(54) OBJECT PLACEMENT WITHIN INTERFACE

(71) Applicant: MICROSOFT CORPORATION, Redmond, WA (US)

(72) Inventors: Vincent J. Pasceri, Kirkland, WA (US); Benjamin John Templeton, Issaquah, WA (US); Michael James Rorke, Seattle, WA (US)

(73) Assignee: Microsoft Corporation, Redmond, WA (US)

(21) Appl. No.: 13/649,497

(22) Filed: Oct. 11, 2012

(51) Int. Cl. G06F 3/048

(52) U.S. Cl. 715/769

(57) ABSTRACT

Among other things, one or more techniques and/or systems are provided for placing an object, such as a user interface element within an interface, such as a graphical user interface (e.g., an application, a website, etc.). When placing the object, a visual state of an object may be transformed based upon initial drag movement of the object. Responsive to the initial drag movement exceeding a transformation threshold, the object is transformed into a precision placement object representing the object. The user may freely move the precision placement object within the interface. A precision point of the precision placement object may not correspond to a touch region of the precision placement object such that the user's finger, for example, may not obscure the object within the interface. Responsive to a placement input, the precision placement object may be transformed to the object, and the object may be placed within the interface.

### BACKGROUND

Many users may interact with content through interfaces, such as a graphical user interface. In one example, a user may interactively plan a driving route through an online mapping interface. In another example, a user may read a news article through a news reading application interface. In another example, a user may share images through an image sharing interface. In this way, various interfaces may allow users to visualize and/or interact with a wide variety of content. As computing devices become more sophisticated, new user input techniques have becomes available, such as mouse input, keyboard input, voice commands, and/or touch input. As an example, touch input through a tablet device may allow a user to select objects, drag and drop objects, and/or perform other commands through touch. Unfortunately, when a user interacts with an object using touch input, such as by a finger or an input apparatus, a user's view of the object may be visually obstructed. For example, the user may be unable to visualize the object because the user's finger may be blocking the user's view of the object. In this way, accuracy in placing the object (e.g., when dragging and dropping the object) may be diminished.

### SUMMARY

This summary is provided to introduce a selection of concepts in a simplified form that are further described below in the detailed description. This Summary is not intended to identify key factors or essential features of the claimed subject matter, nor is it intended to be used to limit the scope of the claimed subject matter. It is to be appreciated that various examples are provided herein, and that such examples are not intended to limit the application, including the scope of the claims. Rather, the examples are intended to, among other things, facilitate understanding, for example.

Among other things, one or more systems and/or techniques for placing an object within an interface are provided herein. It may be appreciated that an interface may correspond to many computer-based interfaces (e.g., graphical user interfaces), such as a news reading application, a map provided by an online mapping website, a video game, an image sharing application, a social network website, an image, a text document provided by a text editing application, a programming development environment, etc. An object may be associated with the interface (e.g., a marker pin for a map, a cursor for a text editing application, an icon, an image, a text box, and/or any type of a user interface element). In one example, the object may correspond to a pre-existing object within the interface (e.g., a marker pin already placed within a map). In another example, the object may correspond to a create new object function, such as a create object touch gesture, an automated process, a create new object menu item, etc.

In one example of placing the object within the interface, an initial drag movement associated with the object may be detected. For example, a user may start to touch and/or drag the object within the interface. An anchor point of the object may remain at an original position (e.g., a point at which the object is anchored onto the interface) during the initial drag movement, but the visual state of the object may be transformed based upon the initial drag movement. In one example of transforming the visual state of the object, an indicator may be associated with the object (e.g., a teardrop shape may be displayed around the object), and may be stretched in a direction of the initial drag movement. Responsive to the initial drag movement exceeding a transformation threshold (e.g., the object is dragged beyond a predefined distance from the anchor point), the object may be transformed into a precision placement object that represents the object.

The user may freely move the precision placement object within the interface based upon reposition movement, such as a drag gesture. For example, a current position of the precision placement object may be translated within the interface based upon detecting such reposition movement. In one example, responsive to detecting a pause input (e.g., a user pauses during the drag gesture), a placement preview may be displayed. For example, information associated with placing the object at a current position of the precision placement object may be displayed as a visual description and/or a textual description. In this way, the user may freely move the precision placement object within the interface and/or visualize placement previews before committing to placing the object within the interface.

Responsive to a placement input associated with the precision placement object (e.g., the user releases the drag gesture by lifting a finger off of the precision placement object in the interface), the precision placement object is transformed to the object. In this way, the object may be placed (e.g., anchored) within the interface at a placement position corresponding to a current position of the precision placement object. For example, the object may be placed at a precision point of the precision placement object (e.g., a tip of a teardrop shaped precision placement object). Because the precision point may not correspond to a touch region used by the user to move the precision placement object, the user may accurately place the object at the precision point without visual obstruction.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of placing an object within an interface.

FIG. 2 is a component block diagram illustrating an exemplary system for transforming a visual state of an object within an interface.

FIG. 3 is a component block diagram illustrating an exemplary system for transforming a visual state of an object within an interface.

FIG. 4 is a component block diagram illustrating an exemplary system for transforming an object into a precision placement object within an interface.

FIG. 5 is a component block diagram illustrating an exemplary system for presenting a placement preview within an interface.

FIG. 6 is a component block diagram illustrating an exemplary system for presenting a placement preview within an interface.

FIG. 7 is a component block diagram illustrating an exemplary system for transforming a precision placement object to an object within an interface.

FIG. 8 is a component block diagram illustrating an exemplary system for transforming a precision placement object to an object within an interface.

FIG. 9 is a component block diagram illustrating an exemplary system for placing an object within an interface.

FIG. 10 is a component block diagram illustrating an exemplary system for placing an object within an interface.

FIG. 11 is an illustration of an exemplary computer-readable medium wherein processor-executable instructions configured to embody one or more of the provisions set forth herein may be comprised.

FIG. 12 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Many interfaces allow users to manipulate objects. For example, a map application may allow users to place marker pins within a map to create a route. Unfortunately, many input techniques, such as touch gestures utilizing a finger or other touch apparatus, may visually block the user's view of the object when moving and/or placing the object within the interface. For example, when a user uses a finger to move a marker pin within a map, the finger may visually obstruct the user's view of the marker pin while dragging the marker pin around the map, thus resulting in a loss of accuracy in placing the marker pin. Accordingly, as provided herein a placement technique is provided for an object that mitigates visual obstruction of the object.

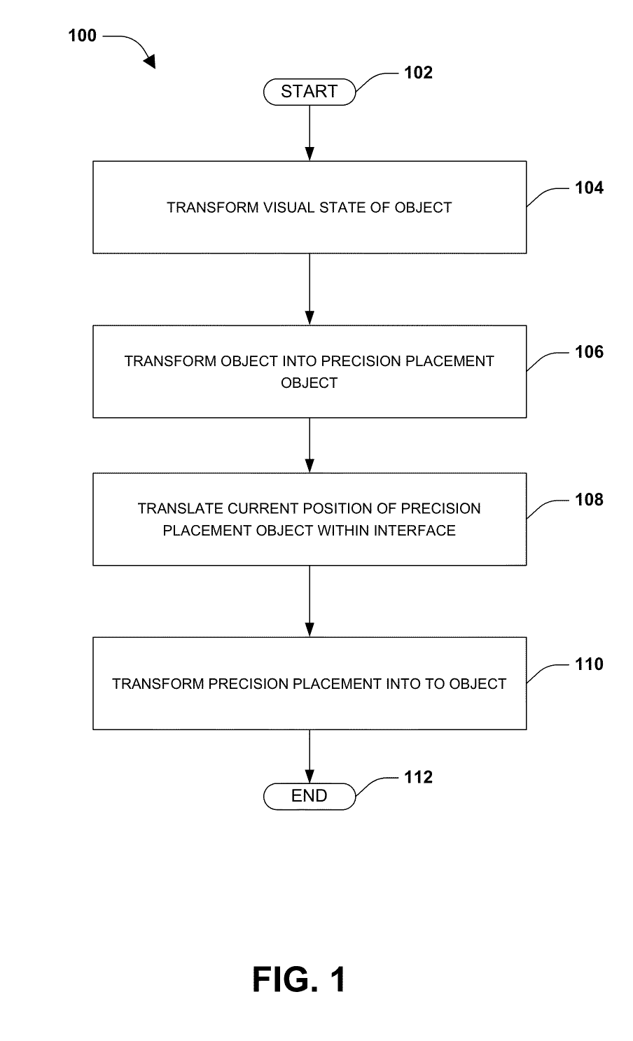

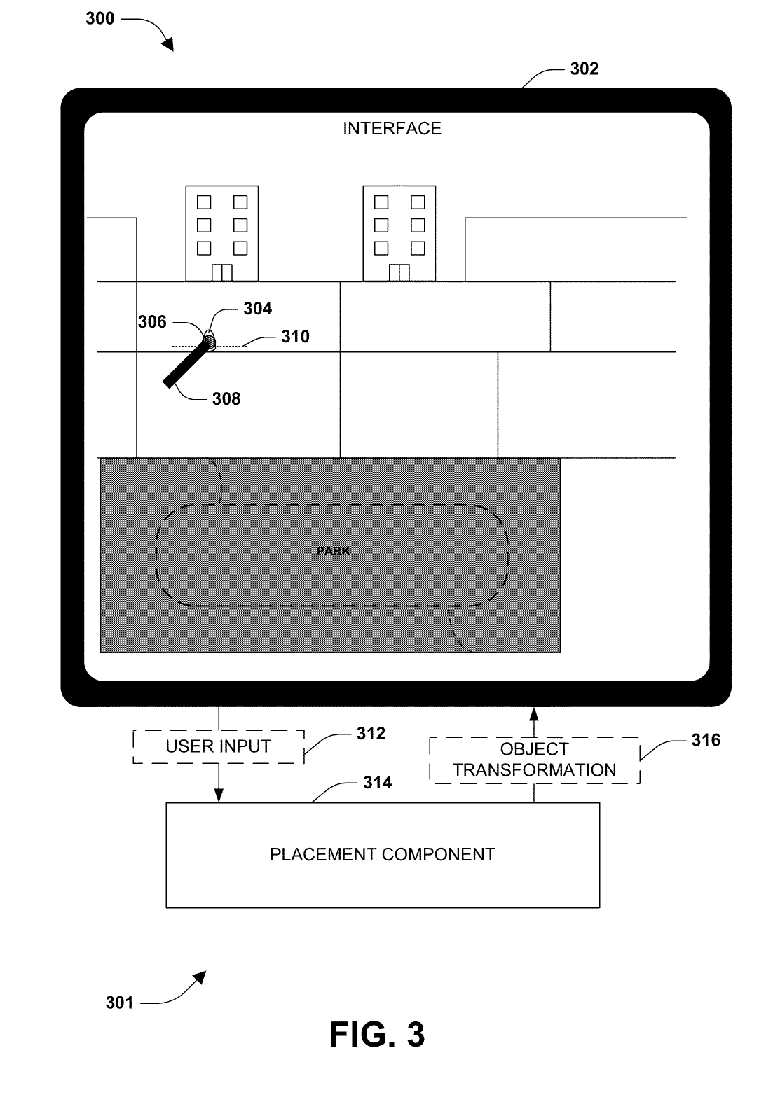

One embodiment of placing an object within an interface is illustrated by exemplary method 100 in FIG. 1. At 102, the method starts. An interface, such as a map interface, for example, may be presented to a user through a computing device, such as a touch screen device. An object, such as a marker pin, for example, may be associated with the interface (e.g., a pre-existing object, an object associated with an automated create objection function, an object associated with a create object gesture, an object associated with a create object menu item, etc.). Responsive to detecting an initial drag movement associated with the object, a visual state of the object may be transformed, at 104 (e.g., example 300 of FIG. 3). For example, a user may use a finger to select and/or drag the object away from an anchor point that anchors the object to the interface at an original position. To mitigate unintended user input (e.g., that may otherwise mistakenly move the object), the object may remain anchored to the anchor point at the original position during transformation of the visual state of the object. In one example of transforming the object, an indicator, such as a teardrop shaped object, may be displayed around the object and/or may be stretched or enlarged according to the initial drag movement. It may be appreciated that various shapes, sizes, configurations, and/or user interface elements may be used as the indictor and (re)sized in a suitable manner. If the initial drag movement does not exceed a transformation threshold (e.g., the user does not move the marker pin past a threshold distance from the original position before releasing the marker pin), the visual state of the object may be transformed to an original visual state.

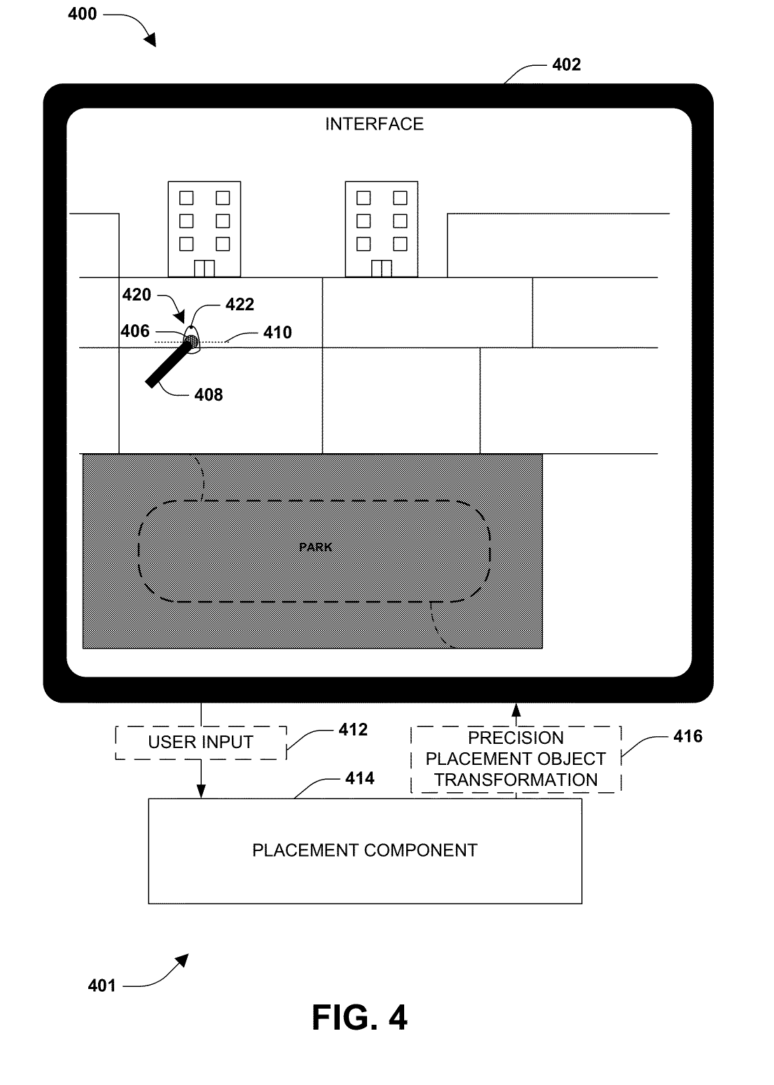

Responsive to the initial drag movement exceeding the transformation threshold (e.g., a particular distance from the original position of the object), the object may be transformed into a precision placement object, at 106 (e.g., example 400 of FIG. 4). The precision placement object may visually represent the object during movement and/or placement of the object because the precision placement object may be displayed according to a particular shape that allows the user to visually observe a precision point of the precision placement object during movement and/or placement, which may enhance placement accuracy. That is, the precision placement object may comprise the precision point that represents a current location of the precision placement object, such that the object may be placed at the current location based upon a placement input. In one example of the precision placement object, the precision placement object may comprise a teardrop shape, where a tip of the teardrop shape corresponds to the precision point. Because the precision point may not be located at a touch region used to “grab/hold” and/or move the precision placement object, the user may freely move the precision placement object using the touch region without obstructing the user's view of the precision point.

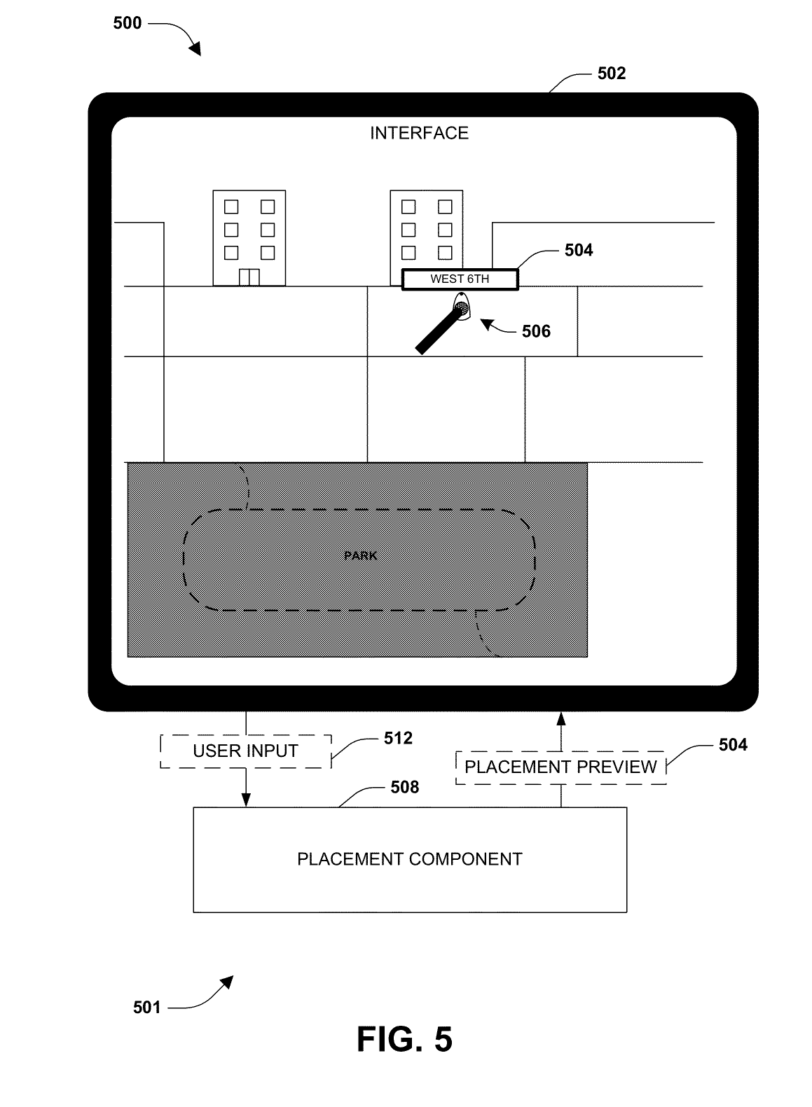

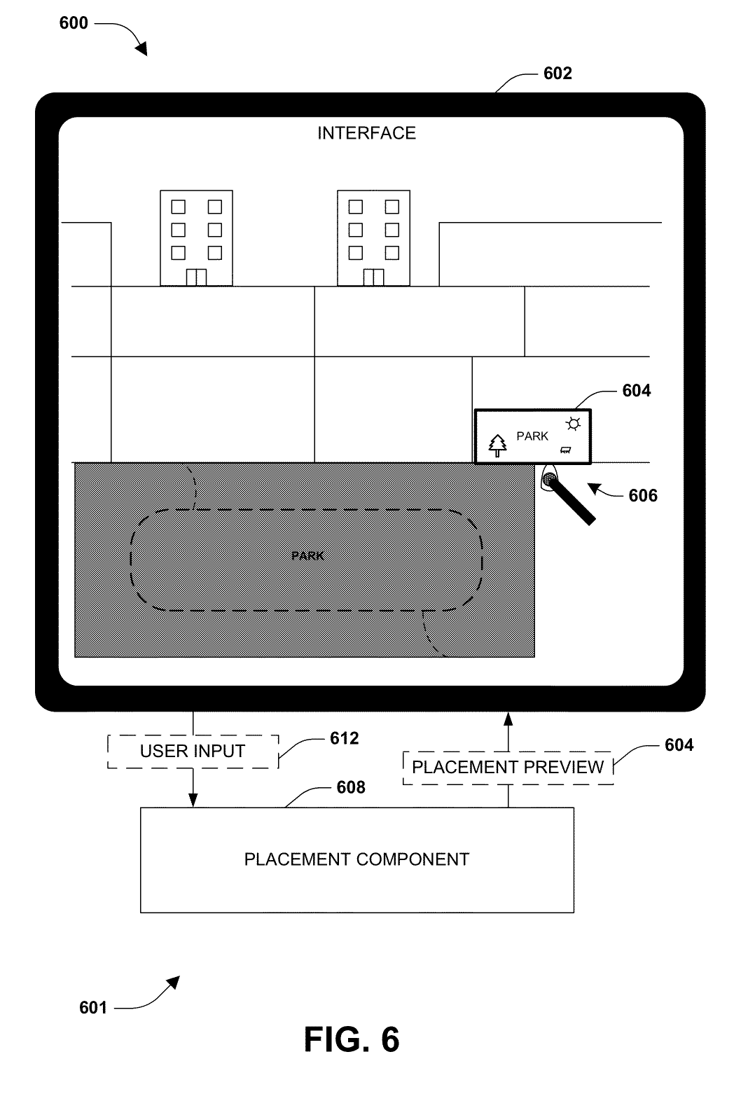

Responsive to detecting a reposition movement associated with the precision placement object (e.g., the user may drag the precision placement object by a finger drag gesture over a touch region of the precision placement object), a current position of the precision placement object may be translated within the interface, at 108 (e.g., example 500 of FIG. 5 and example 600 of FIG. 6). In this way, the user may freely move the precision placement object within the interface by current user input that is detected as the reposition movement (e.g., drag movement by the finger).

In one example, a pause input may be detected (e.g., the user may keep a finger, “holding” the precision placement object, over a region of the interface for a pause duration that is longer than a pause threshold). Responsive to the pause input associated with the precision placement object, a placement preview may be displayed. In one example, the placement preview may comprise a textual description for the object at a position at which the precision placement object is located (e.g., example 500 of FIG. 5). In another example, the placement preview may comprise a visual description for the object at the position (e.g., example 600 of FIG. 6). In the way, the user may preview a potential placement of the object at the position before committing to placement of the object. It may be appreciated that a variety of functions, operations, etc. may be performed based upon user and/or other input (e.g., input gestures) and/or system events (e.g., a timer timeout), etc. In one example, placement of the object may be cancelled based upon a cancel gesture (e.g., a finger swipe) and/or a system event (e.g., a timeout without user input), such that the precision placement object may, for example, be moved to an original position of the object and/or may be visually transformed to the object at the original position, for example. In another example, visual information and/or audio information may be provided to the user (e.g., audio and/or visual instructions (e.g., directions, etc.), contextual information associated with a particular location (e.g., restaurant review(s), etc.), contextual information associated with object placement, etc.) based upon some input (e.g., pause input) and/or a system event (e.g., timeout), for example.

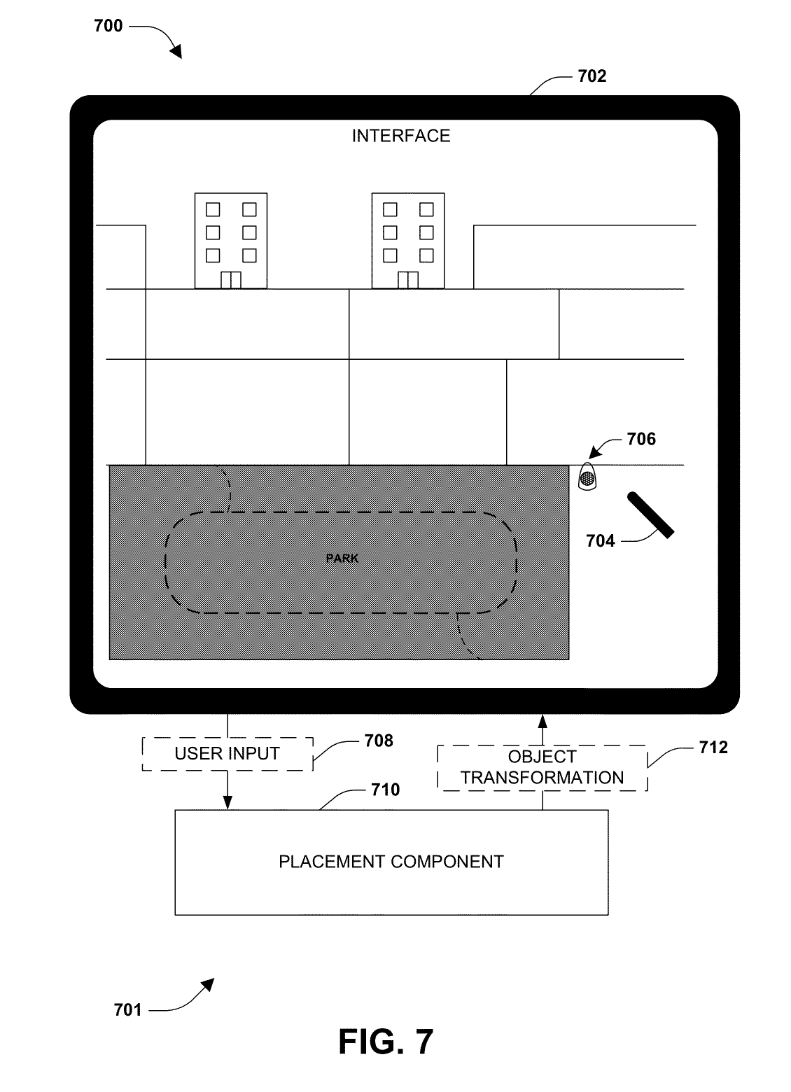

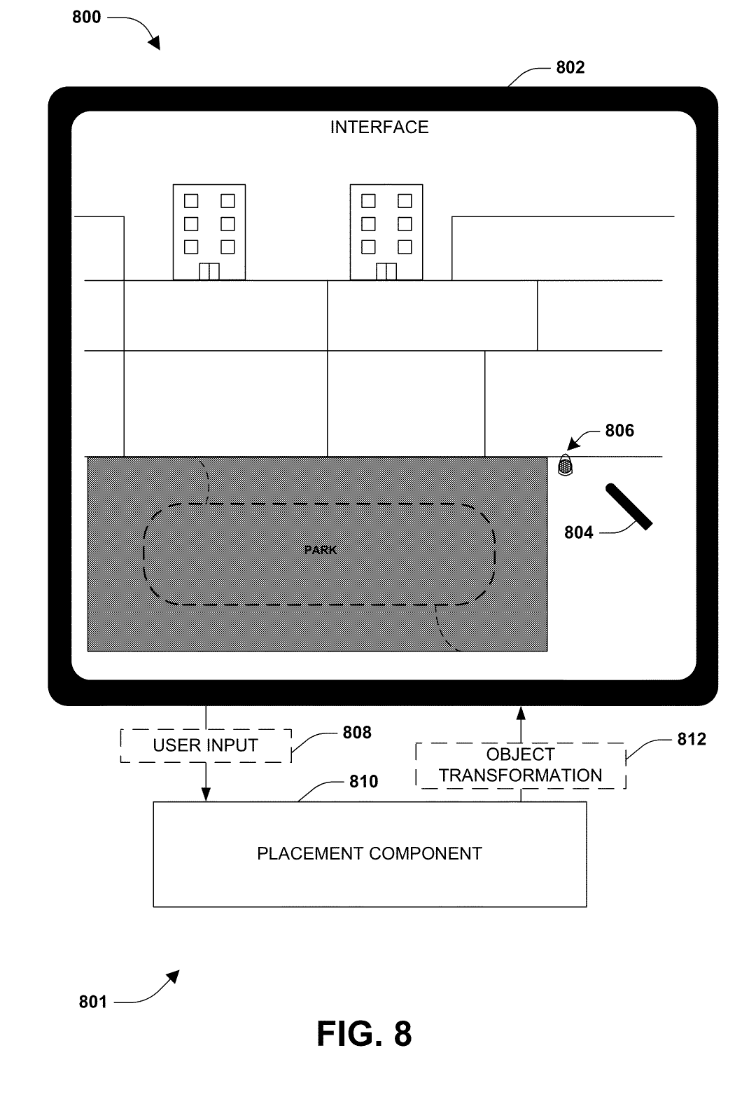

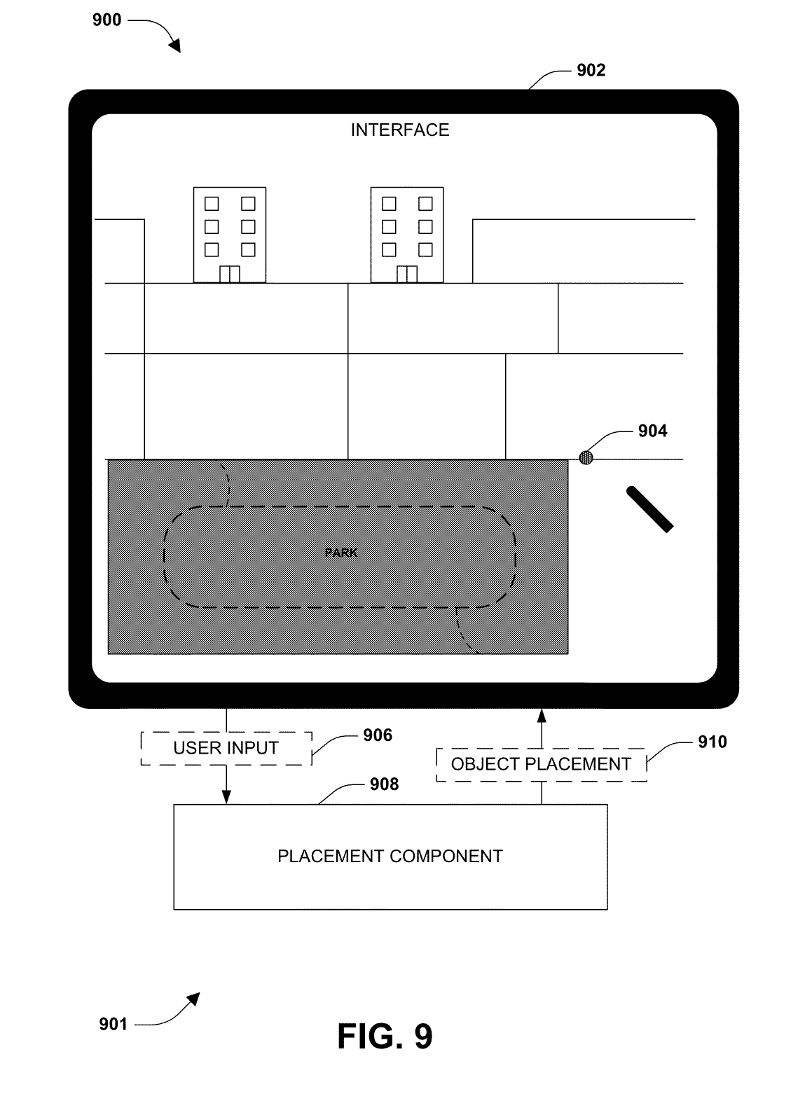

Responsive to a placement input associated with the precision placement object (e.g., a touch release input on a touch device), the precision placement object may be transformed to the object, at 110 (e.g., example 700 of FIG. 7, example 800 of FIG. 8, and/or example 900 of FIG. 9). Accordingly, the object may be placed (e.g., anchored) within the interface. For example, the object may be placed at a placement position corresponding to a current position of the precision placement object represented by the precision point. In this way, the user may place the object within the interface with improve accuracy because the precision placement object, such as the precision point of the precision placement object, may be visible to the user during placement. At 112, the method ends.

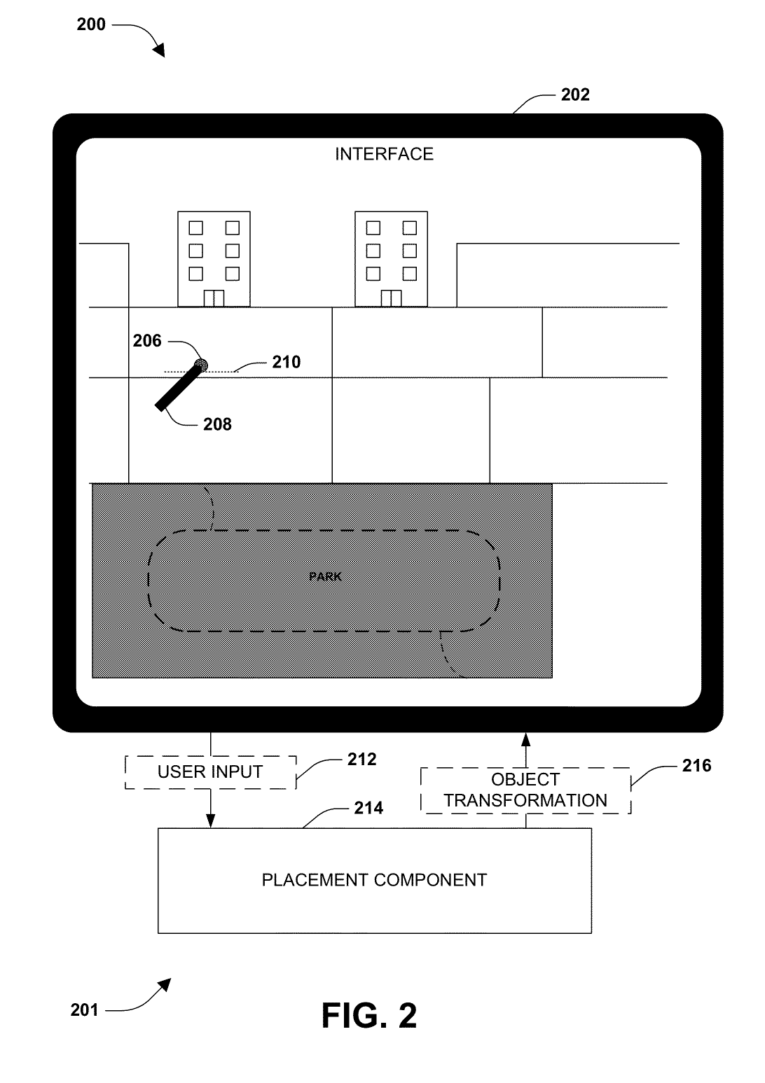

FIG. 2 illustrates an example 200 of a system 201 configured for transforming a visual state of an object 206 within an interface 202. The system 201 may comprise a placement component 214. The placement component 214 may be associated with the interface 202, such as a map interface. The interface 202 may allow a user to place and/or move objects, such as object 206 (e.g., a marker pin), within and/or onto the interface 202. The placement component 214 may be configured to detect user input 212 associated with the interface 202 and/or perform functionality associated with object placement, such as object transformation 216, in response to the user input 212.

In one example, the placement component 214 may detect the user input 212 as an initial drag movement corresponding to the object 206 (e.g., the user may select and/or drag the object 206 using a finger 208). The placement component 214 may determine a transformation threshold 210 based upon the user input 212. In one example, the transformation threshold 210 may correspond to a distance that the user may displace the object 206 from an original position of the object 206 (e.g., an anchor point) before the object 206 is transformed into a precision placement object. Responsive to the initial drag movement displacing the object 206 from the original position, the placement component 214 may transform a visual state of the object 206 (e.g., object transformation 216). For example, a teardrop shaped indictor may be displayed with the object 206 (e.g., example 300 of FIG. 3). The teardrop shaped indicator may be stretched as the initial drag movement displaces the object 206 towards the transformation threshold 210 (e.g., example 300 of FIG. 3). In this way, the placement component 214 may be configured to transform the visual state of the object 206 (e.g., object transformation 216) based upon the initial drag movement (e.g., user input 212).

FIG. 3 illustrates an example 300 of a system 301 configured for transforming a visual state of an object 306 within an interface 302. The system 301 may comprise a placement component 314 associated with the interface 302. It may be appreciated that in one example, the interface 302 may correspond to an interface 202 of FIG. 2. That is, the object 306 may correspond to object 206, where object 306 illustrates a further transformation (e.g., object transformation 316) of a visual state of the object 206 based upon initial drag movement.

In one example, the placement component 314 may detect user input 312 as an initial drag movement corresponding to a user dragging object 306 with a finger 308. The placement component 314 may be configured to transform a visual state of the object 306 based upon the initial drag movement (e.g., object transformation 316). In one example, the placement component 314 may stretch a teardrop shaped indicator 304 as the initial drag movement displaces the object 306 towards a transformation threshold 310. In another example, the placement component 314 may retract the teardrop shape 304 as the initial drag movement displaces the object 306 away from the transformation threshold 310. In this way, the placement component 314 may be configured to transform (e.g., enlarge, shrink, change shape of, etc.) the visual state of the object 306 (e.g., object transformation 316) based upon the initial drag movement (e.g., user input 312).

FIG. 4 illustrates an example 400 of a system 401 configured for transforming an object into a precision placement object 420 within an interface 402. The system 401 may comprise a placement component 414 associated with the interface 402. It may be appreciated that in one example, the interface 402 may correspond to an interface 302 of FIG. 3. That is, the precision placement object 420 may represent an object 306 that has been transformed from the object 306 to the precision placement object 420 based upon initial drag movement associated with the object 306 exceeding a transformation threshold 410. The precision placement object 420 may comprise a touch region 406 (e.g., representing the object 306, such that the user may “grab/hold” and/or move the precision placement object 420 by touching the touch region 406), an indicator (e.g., a teardrop shaped indicator), and/or a precision point 422 (e.g., representing a current position of the precision placement object 420 that may be visible to the user when interacting with the touch region 406 with a finger 408).

In one example, the placement component 414 may detect user input 412 as an initial drag movement of an object, not illustrated, that exceeds the transformation threshold 410. Accordingly, the placement component 414 may transform (e.g., precision placement object transformation 416) the object into the precision placement object 420 (e.g., a new, modified, etc. user interface element representing the object). In one example, the precision point 422 of the precision placement object 420 may be displayed apart from the touch region 406 because the touch region 406 is associated with movement of the precision placement object 420 (e.g., a region where the finger 408 “grabs/holds” the precision placement object 420). In this way, the touch region 406 may be used by the user to freely move the precision placement object 420 within the interface 402 without obstructing the user's view of the precision point 422 representing the current position of the precision placement object 420. The precision point 422 may correspond to the current position of the precision placement object 420, such that the object 406 may be placed within the interface 402 at the precision point 422 based upon a placement input (e.g., example 700 of FIG. 7, example 800 of FIG. 8, and/or example 900 of FIG. 9). In this way, the placement component 414 may be configured to transform the object into the precision placement object 420, which may be moved freely within the interface 402 without obstructing the user's view of the precision placement object 420, such as the precision point 422. For example, the placement component 414 may translate a current position of the precision placement object 420 based upon reposition movement (e.g., a drag gesture) associated with the precision placement object 420.

FIG. 5 illustrates an example 500 of a system 501 configured for presenting a placement preview 504 within an interface 502. The system 501 may comprise a placement component 508 that may be associated with the interface 502. It may be appreciated that in one example, the interface 502 may correspond to an interface 402 of FIG. 4. That is, the precision placement object 506 may correspond to the precision placement object 420, where a current position of the precision placement object 420 has been translated to a location of the precision placement object 506 based upon reposition movement (e.g., a drag gesture).

The placement component 508 may be configured to detect a user input 512 as a pause input associated with the precision placement object 506. For example, the user may be dragging the precision placement object 506 (e.g., detected as reposition movement) within the interface 502 towards a building on West 6^{th} street. Once the precision placement object 506 is near the building, the user may stop the dragging motion, such that the precision placement object 506 pauses near the building. The placement component 508 may detect the pause input, and may display a placement preview 504 within the interface 502. For example, the placement preview 504 may comprise a textual description (e.g., West 6^{th}) for an object (e.g., object 206 of FIG. 2 that is represented by the precision placement object 506) at a position at which the precision placement object 506 is located within the interface 502. In this way, the user may preview information associated with potentially placing the object at a placement position corresponding to a current position of the precision placement object 506 before committing to placing the object.

FIG. 6 illustrates an example 600 of a system 601 configured for presenting a placement preview 604 within an interface 602. The system 601 may comprise a placement component 608 that may be associated with the interface 602. It may be appreciated that in one example, the interface 602 may correspond to an interface 402 of FIG. 4. That is, the precision placement object 606 may correspond to the precision placement object 420, where a current position of the precision placement object 420 has been translated to a location of the precision placement object 606 based upon reposition movement (e.g., a drag gesture).

The placement component 608 may be configured to detect a user input 612 as a pause input associated with the precision placement object 606. For example, the user may be dragging the precision placement object 606 (e.g., detected as reposition movement) within the interface 602 towards a park. Once the precision placement object 606 is near the park, the user may stop the dragging motion, such that the precision placement object 606 pauses near the park. The placement component 608 may detect the pause input, and may display a placement preview 604 within the interface 602. For example, the placement preview 604 may comprise a visual description (e.g., an image of a park) for an object (e.g., object 206 of FIG. 2 that is represented by the precision placement object 606) at a position at which the precision placement object 606 is located within the interface 602. In this way, the user may preview information associated with potentially placing the object at a placement position corresponding to a current position of the precision placement object 606 before committing to placing the object.

FIG. 7 illustrates an example 700 of a system 701 configured for transforming a precision placement object 706 to an object within an interface 702. The system 701 may comprise a placement component 710 that may be associated with the interface 702. It may be appreciated that in one example, the interface 702 may correspond to an interface 602 of FIG. 6, where a placement component 608 may have translated a current position of a precision placement object 606 to a current position of the precision placement object 706 based upon reposition movement.

The placement component 710 may be configured to detect user input 708 as a placement input associated with the precision placement object 706. For example, the placement component 710 may detect that a user removed a finger 704 from the interface 702 (e.g., the finger 704 may have been used to drag the precision placement object 706 to the current position). The placement component 710 may be configured to transform 712 the precision placement object 706 to an object (e.g., a marker pin) that is represented by the precision placement object 706 (e.g., example 800 of FIG. 8 and/or example 900 of FIG. 9). For example, a teardrop shaped indicator of the precision placement object 706 may be collapsed (e.g., shrunken down) and/or a representation of the object within the precision placement object 706 may be moved towards a precision point of the precision placement object 706 during transformation 712, for example. It may be appreciated that in one example, the transformation 712 may corresponding to a partial transformation (e.g., a first transformation sequence out of a complete transformation of the precision placement object 706 to the object), and that a second transformation sequence (e.g., sequentially performed after the first transformation sequence) is illustrated in example 800 of FIG. 8.

FIG. 8 illustrates an example 800 of a system 801 configured for transforming a precision placement object 806 to an object within an interface 802. The system 801 may comprise a placement component 810 that may be associated with the interface 802. It may be appreciated that in one example, the interface 802 may correspond to an interface 702 of FIG. 7, where a placement component 710 may have initiated a transformation 712 of a precision placement object 706 (e.g., a first transformation sequence). Accordingly, example 800 may illustrate a second transformation sequence perform after the first transformation sequence. For example, the placement component 810 may further collapse (e.g., shrink down) a teardrop shaped indicator of the precision placement object 806 and/or may move a representation of the object within the precision placement object 806 towards a precision point of the precision placement object 806 based upon user input 808 corresponding the a placement input (e.g., a user may have removed a finger 804 from the precision placement object 806). In this way, the placement component 810 may transform 812 the precision placement object 806 to the object for placement of the object within the interface 802 (e.g., example 900 of FIG. 9).

FIG. 9 illustrates an example 900 of a system 901 configured for placing an object 904 within an interface 902. The system 901 may comprise a placement component 908. The placement component 908 may be configured to detect user input 906 associated with the interface 902. For example, the placement component 908 may detect the user input 906 as a placement input associated with a precision placement object, not illustrated, that represents the object 904. The placement component 908 may be configured to place (e.g., object placement 910) the object 904 at a placement position corresponding to a current position of the precision placement object, such as a precision point of the precision placement object (e.g., precision point 422 of precision placement object 420 corresponding to a tip of a teardrop shaped indicator). In one example of placing the object 904, the placement component 908 may transform the precision placement object to the object 904 based upon the placement input. Once transformed, the placement component 908 may place (e.g., anchor) the object 904 to the placement position within the interface 902.

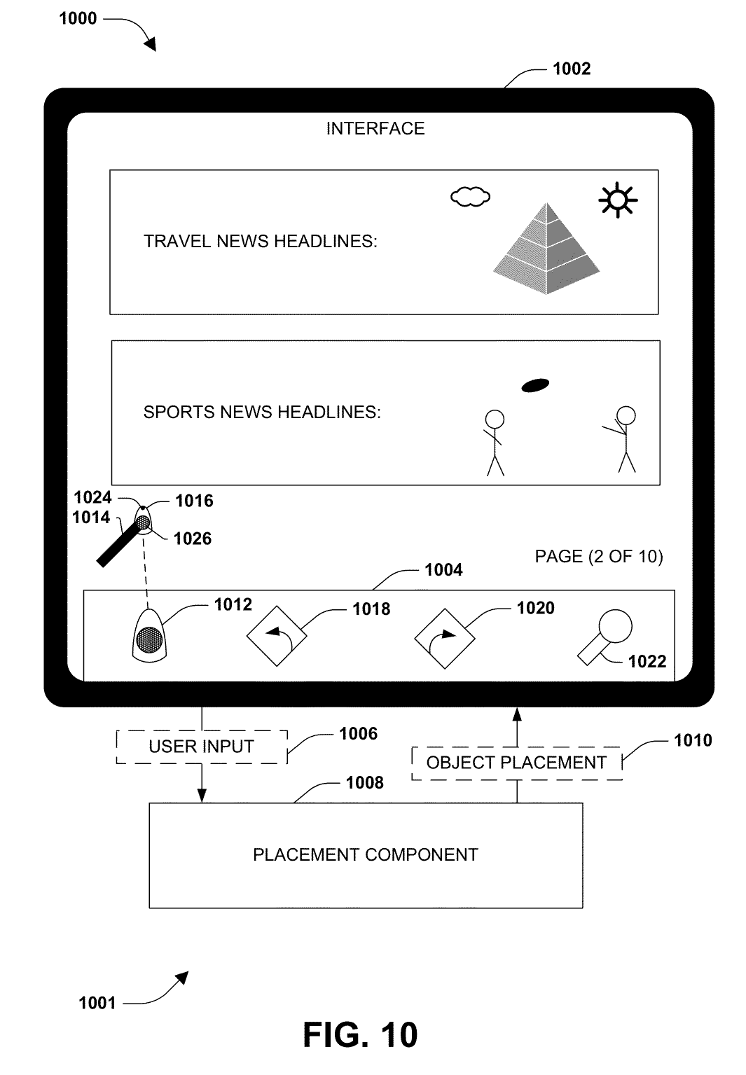

FIG. 10 illustrates an example 1000 of a system 1001 configured to placing an object within an interface 1002. It may be appreciated that the interface 1002 may correspond to any one or more of a variety of computing interfaces, such as a news reading application. The interface 1002 may be associated with one or more objects, such as user interface elements. The interface 1002 may be associated with a menu bar 1004. The menu bar 1004 may comprise a variety of functionality, such as a find function 1022, a navigate to next news page function 1020, a navigate to prior news page function 1018, a create object function 1012, and/or other functions not illustrated.

The system 1001 may comprise a placement component 1008 that may be associated with the interface 1002. The placement component 1008 may be configured to detect user input 1006 associated with the interface 1002. In one example, the placement component 1008 may detect an initial drag movement associated with an object. For example, a user may use an input device 1014 to invoke the create object function 1012. The placement component 1008 may provide the user with a precision placement object 1016 representing the object that is to be created by the create objection function 1012. It may be appreciated that the placement component 1008 may provide the user with the precision placement object 1016 based upon various events (e.g., a create object input gesture, an automated create object function, initial drag movement of a pre-existing object that exceeds a transformation threshold, etc.). The placement component 1008 may translate a current position of the precision placement object 1016 based upon the user input 1006 corresponding to reposition movement associated with the precision placement object 1016 being moved within the interface 1002 (e.g., the input device 1014 may be used to “grab” and/or drag the precision placement object 1016 at the touch region 1026).

The placement component 1008 may be configured to detect a placement input. For example, the input device 1014 may be removed from touching the interface 1002. The placement component 1008 may transform the precision placement object 1016 to the object, and may place (e.g., object placement 1010) the object within the interface 1002. Because the object may be placed at a precision point 1024 of the precision placement object 1016 that does not correspond to the touch region 1026 of the precision placement object 1016, the a user's view of the precision point 1016 may not be obstructed during movement, which may enhance accuracy of object placement 1010.

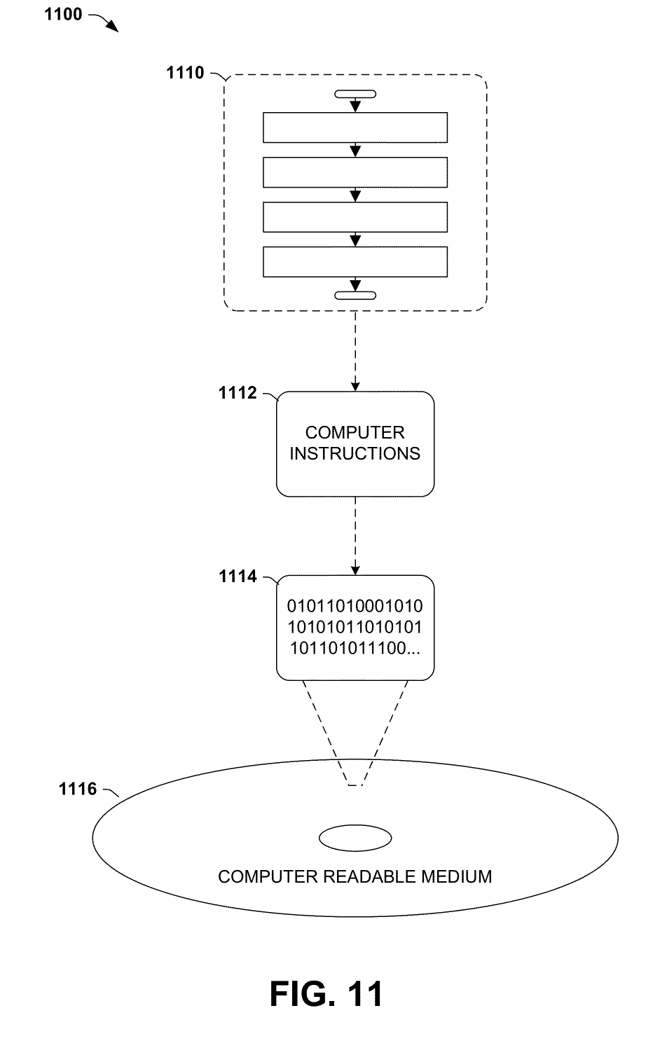

Still another embodiment involves a computer-readable medium comprising processor-executable instructions configured to implement one or more of the techniques presented herein. An exemplary computer-readable medium that may be devised in these ways is illustrated in FIG. 11, wherein the implementation 1100 comprises a computer-readable medium 1116 (e.g., a CD-R, DVD-R, or a platter of a hard disk drive), on which is encoded computer-readable data 1114. This computer-readable data 1114 in turn comprises a set of computer instructions 1112 configured to operate according to one or more of the principles set forth herein. In one such embodiment 1100, the processor-executable computer instructions 1112 may be configured to perform a method 1110, such as at least some of the exemplary method 100 of FIG. 1, for example. In another such embodiment, the processor-executable instructions 1112 may be configured to implement a system, such as, at least some of the exemplary system 201 of FIG. 2, at least some of the exemplary system 301 of FIG. 3, at least some of exemplary system 401 of FIG. 4, at least some of the exemplary system 501 of FIG. 5, at least some of the exemplary system 601 of FIG. 6, at least some of the exemplary system 701 of FIG. 7, at least some of the exemplary system 801 of FIG. 8, at least some of the exemplary system 901 of FIG. 9, and/or at least some of the exemplary system 1001 of FIG. 10, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

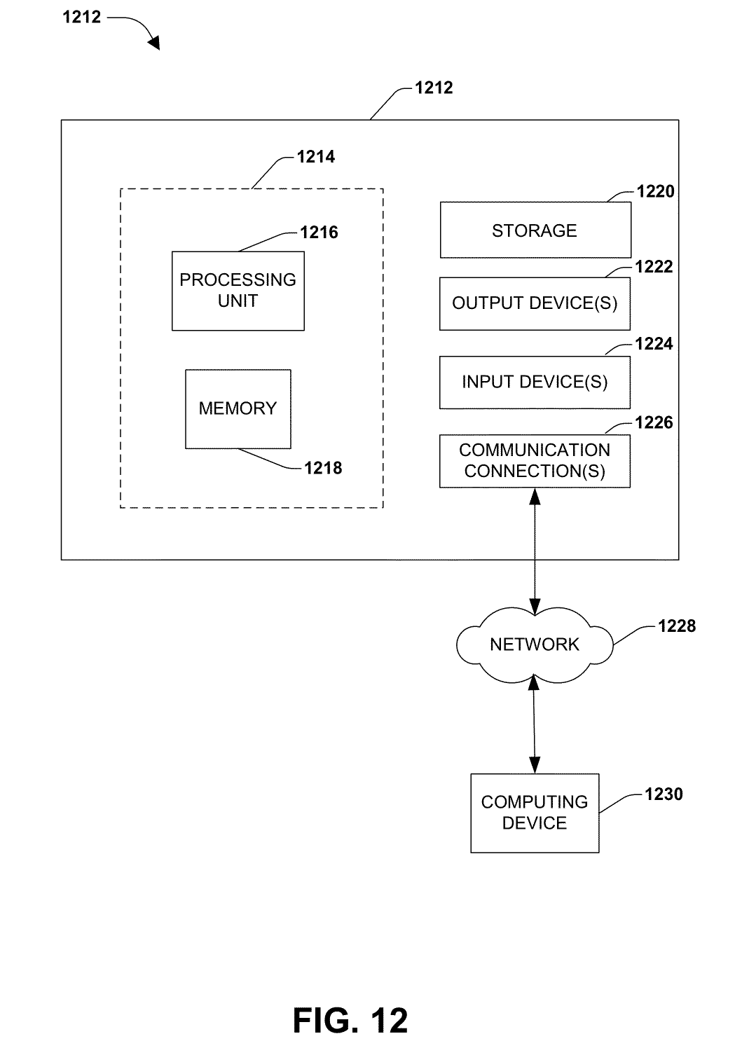

FIG. 12 and the following discussion provide a brief, general description of a suitable computing environment to implement embodiments of one or more of the provisions set forth herein. The operating environment of FIG. 12 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 12 illustrates an example of a system 1210 comprising a computing device 1212 configured to implement one or more embodiments provided herein. In one configuration, computing device 1212 includes at least one processing unit 1216 and memory 1218. Depending on the exact configuration and type of computing device, memory 1218 may be volatile (such as RAM, for example), non-volatile (such as ROM, flash memory, etc., for example) or some combination of the two. This configuration is illustrated in FIG. 12 by dashed line 1214.

In other embodiments, device 1212 may include additional features and/or functionality. For example, device 1212 may also include additional storage (e.g., removable and/or non-removable) including, but not limited to, magnetic storage, optical storage, and the like. Such additional storage is illustrated in FIG. 12 by storage 1220. In one embodiment, computer readable instructions to implement one or more embodiments provided herein may be in storage 1220. Storage 1220 may also store other computer readable instructions to implement an operating system, an application program, and the like. Computer readable instructions may be loaded in memory 1218 for execution by processing unit 1216, for example.

The term “computer readable media” as used herein includes computer storage media. Computer storage media includes volatile and nonvolatile, removable and non-removable media implemented in any method or technology for storage of information such as computer readable instructions or other data. Memory 1218 and storage 1220 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1212. Any such computer storage media may be part of device 1212.

Device 1212 may also include communication connection(s) 1226 that allows device 1212 to communicate with other devices. Communication connection(s) 1226 may include, but is not limited to, a modem, a Network Interface Card (NIC), an integrated network interface, a radio frequency transmitter/receiver, an infrared port, a USB connection, or other interfaces for connecting computing device 1212 to other computing devices. Communication connection(s) 1226 may include a wired connection or a wireless connection. Communication connection(s) 1226 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1212 may include input device(s) 1224 such as keyboard, mouse, pen, voice input device, touch input device, infrared cameras, video input devices, and/or any other input device. Output device(s) 1222 such as one or more displays, speakers, printers, and/or any other output device may also be included in device 1212. Input device(s) 1224 and output device(s) 1222 may be connected to device 1212 via a wired connection, wireless connection, or any combination thereof. In one embodiment, an input device or an output device from another computing device may be used as input device(s) 1224 or output device(s) 1222 for computing device 1212.

Components of computing device 1212 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1212 may be interconnected by a network. For example, memory 1218 may be comprised of multiple physical memory units located in different physical locations interconnected by a network.

Those skilled in the art will realize that storage devices utilized to store computer readable instructions may be distributed across a network. For example, a computing device 1230 accessible via a network 1228 may store computer readable instructions to implement one or more embodiments provided herein. Computing device 1212 may access computing device 1230 and download a part or all of the computer readable instructions for execution. Alternatively, computing device 1212 may download pieces of the computer readable instructions, as needed, or some instructions may be executed at computing device 1212 and some at computing device 1230.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for placing an object within an interface, comprising:
responsive to detecting an initial drag movement associated with the object, transforming a visual state of the object;
responsive to the initial drag movement exceeding a transformation threshold, transforming the object into a precision placement object;
responsive to detecting a reposition movement associated with the precision placement object, translating a current position of the precision placement object within the interface; and
responsive to a placement input associated with the precision placement object, transforming the precision placement object to the object.

2. The method of claim 1, comprising:
responsive to a pause input associated with the precision placement object, displaying a placement preview.

3. The method of claim 2, the placement preview comprising at least one of a textual description or a visual description for the object at a position at which the precision placement object is located.

4. The method of claim 1, the precision placement object comprising a precision point corresponding to the current position of the precision placement object, the precision point not corresponding to a touch region associated with at least one of the reposition movement or the placement input.

5. The method claim 4, the transforming the precision placement object to the object comprising:
placing the object within the interface at a placement position corresponding to the current position of the precision placement object.

6. The method of claim 1, the interface comprising a graphical user interface associated with at least one of a website, a desktop application, a web application, or a mobile device application.

7. The method of claim 1, the object comprising a user interface element.

8. The method of claim 1, comprising:
responsive to a release of the initial drag movement, where the initial drag movement does not exceed the transformation threshold, transforming the visual state of the object to an original visual state.

9. The method of claim 1, comprising:
responsive to user input associated with the object not exceeding the transformation threshold, retaining the object at an original position.

10. The method of claim 1, the object corresponding to least one of a pre-existing object within the interface or a create object functionality.

11. The method of claim 1, at least one of the initial drag movement, the reposition movement, or the placement input corresponding to a touch input on a touch device.

12. The method of claim 1, the transforming a visual state of the object comprising:
retaining an anchor point of the object at an original position.

13. The method of claim 1, comprising:
responsive to the object being transformed into the precision placement object, detecting current user input as the reposition movement.

14. The method of claim 1, the placement input corresponding to a touch release input on a touch device.

15. A system for placing an object within an interface, comprising:
a placement component configured to:
responsive to detecting an initial drag movement associated with the object, transform a visual state of the object;
responsive to the initial drag movement exceeding a transformation threshold, transform the object into a precision placement object;
responsive to detecting a reposition movement associated with the precision placement object, translate a current position of the precision placement object within the interface; and
responsive to a placement input associated with the precision placement object, transform the precision placement object to the object.

16. The system of claim 15, the placement component configured to:
responsive to a pause input associated with the precision placement object, display a placement preview.

17. The system of claim 15, the placement component configured to:
responsive to a placement input associated with the precision placement object, place the object within the interface at a placement position corresponding to a current position of the precision placement object.

18. A computer-readable medium comprising processor-executable instructions that when executed perform a method for manipulating an object within an interface, comprising:
responsive to detecting an initial drag movement associated with the object, transforming a visual state of the object;
responsive to the initial drag movement exceeding a transformation threshold, transforming the object into a precision placement object;
responsive to detecting a reposition movement associated with the precision placement object, translating a current position of the precision placement object within the interface; and
responsive to a pause input associated with the precision placement object, displaying a placement preview.

19. The computer-readable medium of claim 18, comprising:
responsive to a placement input associated with the precision placement object:
transforming the precision placement object to the object; and
placing the object within the interface at a placement position corresponding to a current position of the precision placement object.

20. The computer-readable medium of claim 18, the placement preview comprising at least one of a textual description or a visual description for the object at a position at which the precision placement object is located.
